(19) United States
(12) Patent Application Publication
(10) Pub. No.: US 2007/0092733 A1
(43) Pub. Date: Apr. 26, 2007

(54) Concurrently curable hybrid adhesive composition

(75) Inventors: Jie Yang, Woodbury, MN (US); Albert I. Everaerts, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/259,515

(22) Filed: Oct. 26, 2005

(51) Int. Cl. B32B 27/32; C08L 63/00; B05D 5/06

(52) U.S. Cl. 428/413; 428/355 EP; 427/162; 525/523

(57) ABSTRACT

A curable adhesive composition comprises (a) at least one polymer comprising polymerized units derived (or derivable) from at least one (meth)acryloyl-functional monomer or oligomer; (b) at least one (meth)acryloyl-multifunctional monomer or oligomer; (c) at least one multifunctional epoxide; (d) at least one free radical initiator; and (e) at least one cationic initiator; wherein the composition is optically clear and remains optically clear during and after curing.

### FIELD

This invention relates to curable adhesive compositions. In other aspects, this invention also relates to processes for their use and to adhesive transfer tapes and articles comprising the compositions.

### BACKGROUND

Pressure sensitive adhesives (PSAs) exhibit many desirable characteristics (including ease of application) and have been used in a variety of applications. For more permanent bonding applications, however, some conventional PSAs lack sufficient strength to maintain adherence to some substrates, particularly when exposed to elevated temperatures or relatively high humidity. For example, the application of some conventional PSAs to optical substrates such as poly (methyl methacrylate) or polycarbonate (which are known to be “out-gassing substrates” that are difficult to bond) can result in bubbling and delamination. In optical applications, in particular, such bubbling and delamination can be unacceptable.

Curable adhesives (for example, thermally- or photocurable adhesives) have been used in applications that require substantial bond permanency and high strength adherence. For optical product applications (for example, glazings), curable adhesives have been useful for producing optically clear, strongly adhered laminates (for example, comprising layered optical substrates). Conventional curable adhesives, however, typically are applied in liquid form and can require clamping or fixturing, rather than being provided as a PSA or in a form that is easy to apply (for example, in the form of a tape).

To achieve both strength and ease of application, hybrid compositions have been developed that can be used in optical applications. Hybrid compositions are compositions that can be applied as a PSA and subsequently cured to give higher (for example, structural or semi-structural) bond strength. Such compositions, however, are typically opaque or become opaque upon curing, making them unacceptable for optical use.

Optical clarity, strength, and ease of application, however, are not the only adhesive characteristics that many optical products require. Certain optical laminates (for example, those used in green houses, in vehicle windshields, and in thermoforming/injection molding-related applications) are exposed to harsh environmental or process conditions (for example, heat, ultraviolet light, deformation, elongation, and/or moisture). Thus, to avoid loss of optical clarity, the adhesives used in such laminates must exhibit stability under these conditions.

In addition, the adhesives must have high enough peel adhesion to survive converting operations (for example, saw cutting, die cutting, or laser ablation) without allowing edge lifting (or edge delamination) to occur. Such edge lifting can cause points of water entry and thereby induce haze and delamination problems.

### SUMMARY

Thus, we recognize that there is a need for adhesive compositions that can be used in applications where optical clarity is required and that can be easily applied for efficient manufacturing. Preferably, such compositions will also exhibit sufficiently high peel adhesion to survive converting operations, sufficiently high conformability to survive thermoforming/injection molding processes, and/or will maintain their integrity and optical clarity even when exposed to extreme temperature and moisture conditions. In addition, for use on optical substrates that are not transmissive to the wavelengths of radiation typically used for photocuring (for example, reflective films or films comprising radiation-absorbing compounds) or that are heat sensitive, the curing of the adhesive compositions will preferably be triggerable prior to lamination (that is, the compositions preferably can be activated to initiate the curing of polymerizable components, bonded as a PSA, and then cured to completion).

Briefly, in one aspect, this invention provides a curable composition comprising
(a) at least one polymer comprising polymerized units derived (or derivable) from at least one (meth)acryloyl-functional monomer or oligomer;
(b) at least one (meth)acryloyl-multifunctional monomer or oligomer;
(c) at least one multifunctional epoxide;
(d) at least one free radical initiator (preferably, a free radical photoinitiator); and
(e) at least one cationic initiator (preferably, a cationic photoinitiator).
   The curable composition is optically clear and remains optically clear during and after curing. The composition can optionally further comprise at least one (meth)acryloyl-monofunctional monomer or oligomer and/or at least one monofunctional epoxide.

Preferably, the polymer (component (a)) comprises polymerized units derived from at least one acryloyl-functional monomer or oligomer. More preferably, the polymer is a pressure sensitive adhesive.

It has been discovered that the curable composition of the invention can function as a two-stage adhesive that can first form a PSA film or a heat-activatable adhesive (for ease of application to a substrate) and then, in a second stage (after exposure to actinic radiation or heat), undergo concurrent free radical and cationic polymerizations to form an optically clear polymer network that preferably exhibits at least semi-structural peel strength (that is, a peel adhesion value of at least about 80 N/dm when measured according to the 1800 peel adhesion test method described in the Examples section below, except modified by using a film (Film-]) having a thickness of 50.8 micrometers and a Young's modulus of 3.83×10² Pa in the machine direction and 4.44×10¹² Pa in the transverse direction with a poly(methyl methacrylate) (PMMA) substrate of 3.0 millimeters thickness and an adhesive (composition of the invention) layer of 37.5 micrometers thickness). Since the two polymerizations occur at different rates (with the rate of the cationic reaction generally being slower), the composition can be initiated (to trigger both polymerizations) and then bonded. This feature can be advantageous in bonding optical films or other substrates that are sensitive to or cannot transmit, for example, the triggering heat or radiation. (For example, some solar reflective films are coated with ultraviolet (UV) absorbers, and some reflective films do not transmit in the UV region.) Thus, unlike some conventional curable adhesive compositions, the composition of the invention can be used to form laminates with such substrates.

The curable composition of the invention can have an excellent shelf-life when shielded from radiation and/or thermal exposure. Upon exposure, the composition can cure to form an adhesive that can exhibit relatively high peel adhesion (preferably, at least semi-structural peel strength) to a variety of optical substrates, along with lasting optical clarity and environmental stability. In spite of its hybrid nature, the curable composition of the invention surprisingly can remain optically clear during the curing process and can maintain that optical clarity thereafter, under conditions of relatively high heat and humidity (for example, 90° C. for 500 hours and/or 80° C. and 90 percent relative humidity (RH) for 500 hours).

Thus, at least some embodiments of the composition of the invention can meet the above-stated need for adhesive compositions that can be used in applications where optical clarity is required, that can be easily applied for efficient manufacturing, that can exhibit sufficiently high peel adhesion to survive converting operations, that can exhibit sufficiently high conformability to survive thermoforming/injection molding processes, and/or that can maintain their integrity and optical clarity even when exposed to extreme temperature and moisture conditions. The composition can therefore be useful, for example, in solar reflective film glazing (for example, to bond solar reflective film to poly(methyl methacrylate) (PMMA) or polycarbonate), in making photonics photosensor filter laminates, in thermoforming/injection molding applications, in making plastic touch screens, in making security laminates, and in bonding various types of brightness enhancement films or window films.

In another aspect, this invention also provides a transfer tape comprising a film of the curable composition of the invention borne on at least one release liner.

In yet another aspect, this invention further provides an optical article (for example, an optical laminate or a coated optical sheet) comprising the curable composition of the invention (or an at least partially-cured version thereof) and at least one optical substrate (for example, an optical film).

In a further aspect, this invention also provides a process for producing an optical article (for example, an optical laminate or a coated optical sheet) comprising (a) applying the curable composition of the invention to at least a portion of at least one surface of a first optical substrate; (b) exposing at least the curable composition to actinic radiation or heat; and (c) optionally, bonding a second optical substrate to the composition either before or after the exposing.

### DETAILED DESCRIPTION

### DEFINITIONS

As used in this patent application:

“concurrently curable” means that a plurality of polymerization processes can be simultaneously initiated to proceed together at the same or different rates;

“heat-activatable adhesive” means a composition that, at temperatures above its activation temperature (that is, temperatures above ambient or above about 30° C.), exhibits not only the characteristics of (1) sufficient ability to hold on to an adherend, and (2) sufficient cohesive strength to be cleanly removable from the adherend, but also (3) aggressive and permanent tack, and (4) adherence with no more than finger pressure;

“(meth)acryloyl-functional” means acryloyl- and/or methacryloyl-functional;

“optically clear” means appearing clear to the human eye;

“oligomer” means a molecule that comprises at least two repeat units and that has a molecular weight less than its entanglement molecular weight; such a molecule, unlike a polymer, exhibits a significant change in properties upon the removal or addition of a single repeat unit;

“optical substrate” means a substrate that exhibits at least one optical effect (for example, transmission, reflection, and/or polarization of visible, infrared (IR), or ultraviolet (UV) radiation); and

“pressure sensitive adhesive” means a composition that, at ambient temperatures (that is, temperatures of about 10° C. to about 30° C.), exhibits not only the characteristics of (I) sufficient ability to hold on to an adherend, and (2) sufficient cohesive strength to be cleanly removable from the adherend, but also (3) aggressive and permanent tack, and (4) adherence with no more than finger pressure. Materials that have been found to function well as PSAs or as heat-activatable adhesives include polymers designed and formulated to exhibit the requisite viscoelastic properties resulting in a desired balance of tack, peel adhesion, and shear holding power.

Polymer Component

The polymer component of the curable composition of the invention comprises polymerized units of at least one (meth)acryloyl-functional monomer or oligomer. Preferably, the polymer component comprises polymerized units of at least one acryloyl-functional monomer or oligomer. As indicated above, acryloyl- and methacryloyl-functional monomers (for example, acrylate and methacrylate monomers) are referred to collectively herein as “(meth)acryloyl-functional” monomers. Polymers prepared from one or more of'such monomers, optionally in combination with any one or more of a variety of other useful ethylenically unsaturated monomers, will be referred to collectively as “poly(meth)acrylates.” The polymers can be homopolymers or copolymers. Preferably, the polymer component has a glass transition temperature (Tg; measured by differential scanning calorimetry (DSC)) that is less than or equal to 50° C. (more preferably, less than or equal to 20° C.).

Such polymers and their monomers are well-known in the polymer and adhesive arts, as are methods of their preparation. Many such polymers can be useful as pressure sensitive adhesives.

Specific examples of poly(meth)acrylate polymers useful according to the invention include those prepared from free-radically polymerizable acrylate monomers or oligomers such as those described in U.S. Pat. No. 5,252,694 (Willett et al.) at column 5, lines 35-68, the description of which is incorporated herein by reference. While any of a variety of different poly(meth)acrylates can be used, it can be preferable in order to enhance stability and clarity, and to provide an inter-reacted interpenetrating polymeric network (IPN), for the poly(meth)acrylate to include one or more reactive functional groups that can be reacted to connect the poly(meth)acrylate directly or indirectly to the polyepoxide that forms during curing of the curable composition.

These reactive functional groups can be any known reactive groups (for example, hydroxyl (—OH) or carboxylic acid (—COOH) groups), provided that the resulting polymer component does not significantly interfere with the cationic polymerization of the epoxide component (for example, due to the presence of groups such as amino groups, which can react with cationic initiator fragments). Reactive functional groups can be included in a poly(meth)acrylate, for example, by including an appropriate monomer in preparing the poly(meth)acrylate (for example, a (meth)acrylic acid monomer or a hydroxy-functional (meth)acrylate monomer).

Alternatively, inter-reaction between the poly(meth)acrylate and the polyepoxide can be achieved through the use of multifunctional monomers such as epoxy acrylates, in conjunction with grafting agents that can react with the poly(meth)acrylate. Another means of producing an inter-reacted IPN is by including an epoxide group on the poly(meth)acrylate backbone.

Representative examples of monomers that are useful in preparing the polymer component of the curable composition of the invention include specifically, but not exclusively, those of the following classes:

Class A—acrylic acid esters of an alkyl alcohol (preferably, a non-tertiary alcohol) that contains from 1 to about 14 (preferably, from 1 to about 10) carbon atoms (for example, methyl acrylate, ethyl acrylate, n-butyl acrylate, t-butyl acrylate, hexyl acrylate, isooctyl acrylate, 2-ethylhexyl acrylate, isononyl acrylate, isobornyl acrylate, phenoxyethyl acrylate, decyl acrylate, dodecyl acrylate, and the like, and mixtures thereof);

Class B—methacrylic acid esters of an alkyl alcohol (preferably, a non-tertiary alcohol) that contains from 1 to about 14 (preferably, from 1 to about 10) carbon atoms (for example, methyl methacrylate, ethyl methacrylate, n-propyl methacrylate, n-butyl methacrylate, isobutyl methacrylate, t-butyl methacrylate, and the like, and mixtures thereof);

Class C—(meth)acrylic acid monoesters of polyhydroxy alkyl alcohols (for example, 1,2-ethanediol, 1,2-propanediol, 1,3-propane diol, the various butane diols, the various hexane diols, glycerol, and the like, and mixtures thereof); such esters are often referred to as hydroxyalkyl (meth)acrylates;

Class D—macromeric (meth)acrylates (for example, (meth)acrylate-terminated styrene oligomers and (meth)acrylate-terminated polyethers, such as those described in International Patent Publication No. WO 84/03837 (Snyder et al.), the descriptions of which are incorporated herein by reference, and the like, and mixtures thereof);

Class E—(meth)acrylic acids and their salts with alkali metals (for example, lithium, sodium, potassium, and the like, and mixtures thereof).

Preferred monomers include those of Classes A, B, C, as well as acrylic acid and methacrylic acid, and the like, and mixtures thereof. More preferred are those of Classes A and B that have from 1 to about 10 carbon atoms, as well as acrylic acid and methacrylic acid, and mixtures thereof. Most preferred are isooctyl acrylate, methyl acrylate, acrylic acid, butyl acrylate, 2-ethylhexyl acrylate, ethyl acrylate, hydroxy-ethyl acrylate, methyl methacrylate, ethyl methacrylate, butyl methacrylate, and mixtures thereof.

(Meth)acryloyl-Functional Monomers and/or Oligomers

The curable composition of the invention comprises at least one (meth)acryloyl-multifunctional monomer or oligomer (containing at least two (meth)acryloyl groups). During the curing of the composition, this component can polymerize to form a crosslinked polymer network. If desired, the composition can optionally further contain at least one (meth)acryloyl-monofunctional monomer or oligomer (containing only one (meth)acryloyl group), which can co-polymerize with the multifunctional monomers and/or oligomers. The inclusion of monofunctional monomers and/or oligomers can be preferred (for example, to serve as a reactive diluent or as a plasticizer, or to tailor the crosslink density or tack of the resulting polymer) but is generally not necessary.

Selection of the (meth)acryloyl-functional monomers and/or oligomers can be based on the desired performance criteria or characteristics of the resulting cured or curable composition. In one respect, it can be desirable that the composition have pressure sensitive adhesive characteristics for ease of application to substrates (as well as for ease of removability when necessary). In another respect, however, heat and humidity stability can be particularly desirable characteristics for the composition when it is used in laminates intended for outdoor use or for use in other environments having elevated temperatures and/or high humidity. The cohesive and adhesive strengths of the composition can be modified by the selection of (meth)acryloyl-group containing monomers and/or oligomers of the appropriate types, functionalities, and amounts to provide a desired polymeric network.

Useful mono- and multifunctional (meth)acryloyl-group-containing monomers include alkyl (meth)acrylates, aryloxyalkyl (meth)acrylates, hydroxyalkyl (meth)acrylates, and the like, and combinations thereof; preferably (meth)acryloyl-functional monomers that are essentially completely miscible with the other components of the curable composition and that have sufficiently low vapor pressures that little material loss occurs during processing. Preferably, the monomers are essentially non-volatile (for example, having vapor pressures that are less than or equal to 1 kPa at 25° C.; more preferably, less than or equal to 0.5 kPa at 25° C.; most preferably, less than or equal to 0.1 kPa at 25° C.).

Representative examples of suitable monofunctional monomers include methyl acrylate, ethyl acrylate, n-butyl acrylate, isobutyl acrylate, t-butyl acrylate, ethyl methacrylate, butyl methacrylate, ethyltriglycol methacrylate, isobomyl acrylate, isobomyl methacrylate, acetoacetoxyethyl methacrylate, acetoacetoxyethyl acrylate, acetoacetoxypropyl acrylate, acetoacetoxybutyl acrylate, 2-ethylhexyl acrylate, decyl acrylate, lauryl acrylate, stearyl acrylate, 2-hydroxyethyl acrylate, 2-hydroxypropyl acrylate, 2-hydroxyethyl methacrylate, 2-hydroxypropyl methacrylate, β-ethoxyethyl acrylate, cyclohexyl acrylate, hexyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, acryloyloxyethyl phthalate, acryloyloxy succinate, 2-ethylhexyl carbitol acrylate, phthalic acid monohydroxyethyl acrylate, glycidyl methacrylate, N-methylol acrylamide-butyl ether, N-methylol acrylamide, acrylamide, dicyclopentenyloxyethyl acrylate, dicyclopentenyl acrylate, dicyclopentenyloxyethyl acrylate, and the like, and mixtures thereof.

Preferred monofunctional monomers include isobomyl acrylate, isobornyl methacrylate, decyl acrylate, lauryl acrylate, stearyl acrylate, 2-hydroxyethyl methacrylate, 2-hydroxypropyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, and the like, and mixtures thereof (with tetrahydrofurfuryl methacrylate, 2-hydroxyethyl methacrylate, 2-hydroxypropyl methacrylate, 2-phenoxyethyl methacrylate, and 2-phenoxypropyl methacrylate, and mixtures thereof being more preferred).

Multifunctional monomer(s) (compounds possessing at least two polymerizable double bonds in one molecule) can be utilized to, for example, effect crosslinking. Representative examples of such multifunctional monomers include ethylene glycol diacrylate; 1,2-propylene glycol diacrylate; 1,3-butylene glycol diacrylate; 1,6-hexanediol diacrylate; neopentylglycol diacrylate; trimethylolpropane triacrylate; polyoxyalkylene glycol diacrylates such as dipropylene glycol diacrylate, triethylene glycol diacrylates, tetraethylene glycol diacrylates, polyethylene glycol diacrylate; ethylene glycol dimethacrylate; 1,2-propylene glycol dimethacrylate; 1,3-butylene glycol dimethacrylate; 1,6-hexanediol dimethacrylate; neopentylglycol dimethacrylate; bisphenol-A-dimethacrylate; trimethylolpropane trimethacrylate; polyoxyalkylene glycol dimethacrylates such as dipropylene glycol dimethacrylate, triethylene glycol dimethacrylates, tetraethylene glycol dimethacrylates, polyethylene glycol dimethacrylate; N,N-methylene-bis-methacrylamide; allyl acrylate; allyl methacrylate; ditrimethylolpropane tetraacrylate; dipentaerythritol pentaacrylate; and the like; and mixtures thereof.

Preferred multifunctional monomers include ethylene glycol diacrylate; 1,2-propylene glycol diacrylate; 1,3-butylene glycol diacrylate; 1,6-hexanediol diacrylate; trimethylolpropane triacrylate; ethylene glycol dimethacrylate; 1,2-propylene glycol dimethacrylate; 1,3-butylene glycol dimethacrylate; 1,6-hexanediol dimethacrylate; trimethylolpropane trimethacrylate; and mixtures thereof; with ethylene glycol diacrylate; 1,2-propylene glycol diacrylate; 1,3-butylene glycol diacrylate; 1,6-hexanediol diacrylate; trimethylolpropane triacrylate; and mixtures thereof being more preferred.

Suitable mono- and multifunctional (meth)acryloyl-group-containing oligomers for use in preparing the curable composition of the invention include those that can be miscible with the other components of the curable composition. A class of such oligomers is that which can be represented by formula I below: 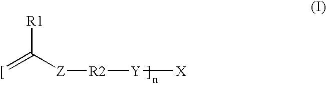
where R1 is H or CH₃; Z is selected from ester and amide groups;

R2 is (CH₂)ₘ, where m is an integer of 1 to about 6; Y is selected from carbonate, ester, ether, and amide groups; X is an n-valent radical group such as, for example, a polyol linkage or an alkyl group; and n is an integer greater than or equal to 1 (preferably, an integer of 1 to about 6). Exemplary compositions can include at least one monofunctional oligomer and at least one multifunctional oligomer having from 2 to about 5 (meth)acryloyl functionalities per molecule.

Alternatively, the (meth)acryloyl-functional oligomers can be polyester (meth)acrylate oligomers, poly(meth)acrylate oligomers having polymerizable (meth)acryloyl functionality, polyether (meth)acrylate oligomers, polycarbonate (meth)acrylate oligomers, and the like, and mixtures thereof. Suitable (meth)acrylate oligomers include, for example, commercially available products such as CN131, an aromatic monoacrylate, and CN132, an aliphatic diacrylate, both of which are available from Sartomer Co. (Exton, Pa.), and ACTILANE 420 difunctional acrylate diluent (Akzo Nobel Resins, Baxley, Ga.). Useful polyester acrylated oligomers include CN292, CN2200, and CN2255 from Sartomer Co. (Exton, Pa.) and EBECRYL 81, 83, 450, and 2047 from UCB Chemicals (Smyrna, Ga.). Suitable polyether acrylated oligomers include GENOMER 3497, available from Rahn USA Corp. (Aurora, Ill.) and CN550 from Sartomer Co. (Exton, Pa.).

Epoxide Component

Suitable multifunctional epoxide materials for use according to the invention will be recognized by those of skill in the chemical and structural adhesive arts and include those that can be miscible with the other components of the curable composition. Useful epoxide materials include multifunctional epoxide group-containing monomers, macromers, oligomers, and mixtures thereof (sometimes termed “epoxy resins”), which can be aliphatic, alicyclic, or aromatic.

If desired, the composition can optionally further contain at least one monofunctional epoxide, which can co-polymerize with the multifunctional epoxide. The inclusion of monofunctional epoxides can be preferred (for example, to serve as a reactive diluent or as a plasticizer, or to tailor the crosslink density or tack of the resulting polymer) but is generally not necessary. Optionally and preferably, the mono- or multifunctional epoxides can include a functionality that can be reacted directly or through a crosslinker or other linking agent to the above-described polymer component to form an inter-reacted interpenetrating polymer network, as mentioned above.

Useful epoxide materials include cationically-polymerizable monomers, a large variety of which are well-known. See, for example, the monomers described in U.S. Pat. No. 5,897,727 (Staral et al.), the description of which is incorporated herein by reference. Useful epoxide materials are also described in U.S. Pat. No.5,252,694 (Willett et al.) (for example, at column 4, line 30, through column 5, line 34), the description of which is incorporated herein by reference.

Preferred epoxide materials include difunctional alicyclic, aliphatic, and aromatic epoxide materials. Examples include bisphenol A and bisphenol F epoxides such as those commercially available under the trade names EPON 828, EPON 100 IF, and EPONEX Resin 1510 (Shell Chemicals, Houston, Tex.). Examples of useful alicyclic epoxide monomers include the ERL series of alicyclic epoxide monomers such as ERL-4221 or ERL-4206 (Union Carbide, Danbury, Conn.).

Monofunctional epoxides include the class of materials described as reactive diluents and include glycidyl ethers such as butyl glycidyl ether commercially available as HELOXY Modifier 61 from Resolution Performance Products, Houston, Tex.; 2-ethylhexyl glycidyl ether commercially available as HELOXY Modifier 116 from Resolution Performance Products, Houston, Tex.; cresyl glycidyl ether commercially available as HELOXY Modifier 62 from Resolution Performance Products, Houston, Tex.; nonylphenyl glycidyl ether commercially available as HELOXY Modifier 64 from Resolution Performance Products, Houston, Tex.; phenyl glycidyl ether commercially available as HELOXY Modifier 63 from Resolution Performance Products, Houston, Tex.; p-tert-butylphenyl glycidyl ether commercially available as HELOXY Modifier 65 from Resolution Performance Products, Houston, Tex.; C₈₋₁₀ aliphatic alcohol glycidyl ethers commercially available as HELOXY Modifier 7 from Resolution Performance Products, Houston, Tex.; C₁₂₋₁₄ aliphatic alcohol glycidyl ethers commercially available as HELOXY Modifier 8 from Resolution Performance Products, Houston, Tex.; monofunctional bisphenol A-based liquid epoxy resins commercially available as DER 321, DER 323, DER 324 and DER 325 from Dow Chemical, Midland, MI; glycidyl esters such as the glycidyl ester of neodecanoic acid available commercially as CARDURA E-10P from Resolution Performance Products, Houston, Tex.; and the like; and mixtures thereof.

Preferred epoxides can be selected, in combination with other composition components, to provide a desired balance of properties including clarity, bond strength, integrity, and stability.

Initiators

Free radical initiators that are useful for reacting or polymerizing (meth)acryloyl-functional materials in accordance with the invention are well-known. Suitable free radical photoinitiators include benzoin ethers (for example, benzoin methyl ether and benzoin isopropyl ether), substituted benzoin ethers (for example, anisoin methyl ether), substituted acetophenones (for example, 2,2-diethoxyacetophenone and 2,2-dimethoxy-2-phenylacetophenone), substituted alpha-ketols (for example, 2-methyl-2-hydroxypropiophenone), aromatic phosphine oxides (for example, bis(2, 4, 6-trimethylbenzoyl)phenyl phosphine oxide), aromatic sulfonyl chlorides (for example, 2-naphthalene-sulfonyl chloride), photoactive oximes (for example, 1-phenyl-1,2-propanedione-2(O-ethoxycarbonyl)oxime), and the like, and mixtures thereof.

Useful thermal free radical initiators include, but are not limited to, the following: (1) azo compounds such as, for example, 2,2′-azo-bis(isobutyronitrile), dimethyl 2,2′-azo-bis(isobutyrate), azo-bis(diphenyl methane), and 4,4′-azo-bis(4-cyanopentanoic acid); (2) peroxides such as, for example, hydrogen peroxide, benzoyl peroxide, cumyl peroxide, tert-butyl peroxide, cyclohexanone peroxide, glutaric acid peroxide, lauroyl peroxide, and methyl ethyl ketone peroxide; (3) hydroperoxides such as, for example, tert-butyl hydroperoxide and cumene hydroperoxide; (4) peracids such as, for example, peracetic acid, perbenzoic acid, potassium persulfate, and ammonium persulfate; (5) peresters such as, for example, diisopropyl percarbonate; (6) thermal redox initiators; and the like; and mixtures thereof.

Preferred free radical initiators are free radical photoinitiators (for example, because of their ease of general use and of simultaneous initiation, their enablement of solventless processing, and their storage stability). More preferred are free radical photoinitiators selected from substituted acetophenones, aromatic phosphine oxides, and mixtures thereof (most preferably, those selected from substituted acetophenones, and mixtures thereof).

Cationic initiators, which can be used to cure epoxides in accordance with the invention, are also well-known. Useful cationic photoinitiators include any of a variety of known useful materials such as onium salts, certain organometallic complexes, and the like, and mixtures thereof. A description of exemplary organometallic complexes, as well as their use with a number of epoxides, can be found, for example, in U.S. Pat. No. 5,252,694 (Willett et al.), U.S. Pat. No. 5,897,727 (Staral et al.), and U.S. Pat. No. 6,180,200 (Ha et al.), the descriptions of which are incorporated herein by reference.

Useful onium salts include those having the structure AX, wherein A can be an organic cation (selected from, for example, diazonium, iodonium, and sulfonium cations; preferably selected from diphenyliodonium, triphenylsulfonium, and phenylthiophenyl diphenylsulfonium), and X is an anion (for example, an organic sulfonate or a halogenated metal or metalloid). Particularly useful onium salts include, but are not limited to, aryl diazonium salts, diaryl iodonium salts, and triaryl sulfonium salts. Additional examples of useful onium salts include those described in U.S. Pat. No. 5,086,086 (Brown-Wensley et al.) (for example, at column 4, lines 29-61), the descriptions of which are incorporated herein by reference.

Useful cationic thermal initiators include imidazoles, quaternary ammonium salts of super acids (for-example, a quaternary ammonium salt-of SbF₆), and the like, and mixtures thereof.

Preferred cationic initiators are cationic photoinitiators (for example, because of their ease of general use and of simultaneous initiation, their enablement of solventless processing, and their storage stability). More preferred are cationic photoinitiators selected from onium salts, and mixtures thereof (most preferably, those selected from iodonium salts, and mixtures thereof).

Optional Components

Optionally, one or more photosensitizers can be included in the curable composition to alter the wavelength sensitivity of a photoinitiator. Representative examples of useful photosensitizers include anthracene, benzophenone, perylene, henothiazine, xanthone, thioxanthone, acetophenone, fluorenone, anthraquinone, 9-methylanthracene, 2-ethyl-9,10-dimethoxyanthracene, 9,10-diethoxy anthracene, camphorquinone, 1,3-diphenylisobenzofuran, and the like, and mixtures thereof.

A grafting agent can also be used, if desired, to cause inter-reaction of the polymer and epoxide components or to crosslink the polymer component itself. Such a grafting agent can serve to generate free radicals on the polymer component, which can then react with, for example, (meth)acryloyl-functional epoxides or with other grafting agent-generated free radicals on the polymer. Examples of useful grafting agents include 4-acryloxy benzophenone (ABP) and triazine-based agents (for example, the chromophore-substituted halomethyl-s-triazine materials described in U.S. Pat. No. 4,330,590 (Vesley et al.), the description of which is incorporated herein by reference).

For example, to form inter-reacted IPNs, epoxy-acrylates such as EBECRYL 1561 (available from UCB, Smyrna, Ga.) can be used in conjunction with a grafting agent. The grafting agent-generated free radical sites on the polymer can react with the acrylate groups of the epoxy-acrylate, and the epoxide component can react with the epoxide groups of the epoxy-acrylate. The addition of a free radical initiator can improve reaction efficiency.

Grafting agents can also enable crosslinking of the polymer component through reaction of the grafting agent-generated free radical sites with the (meth)acryloyl-multifunctional monomers or oligomers. Addition of a free radical initiator can improve the reaction efficiency.

One or more crosslinkers can be included in the composition in amounts that can improve the properties of the resulting cured composition by effecting crosslinking of the poly(meth)acrylate. Useful amounts are generally known in the art and can generally be chosen such that the crosslinker(s) do not significantly interfere with the epoxide polymerization. The useful amounts of crosslinker for a particular composition will be dependent upon a variety of factors including, for example, the chemical nature of the crosslinker, the chemical nature of the polymerizable components, and the desired properties of the curable and cured compositions. Examples of useful crosslinkers include multivalent metal ions and the like.

Other materials that can be included in the curable composition include mono- and polyols, tackifiers, and reinforcing agents, some of which can copolymerize with the free radically- or cationically-polymerizable components or can polymerize independently, as well as other additives commonly used in adhesive systems.

While solventless embodiments are within the scope of the invention, solvents are preferably used in preparing the curable composition (preferably, organic solvents). Useful solvents include acetone, methyl-ethyl-ketone, ethyl acetate, heptane, toluene, cyclopentanone, methyl cellosolve acetate, methylene chloride, nitromethane, methyl formate, gamma-butyrolactone, propylene carbonate, 1,2-dimethoxyethane (glyme), and the like, and mixtures thereof.

Preparation of Curable Composition

The curable composition of the invention can be prepared by conventional methods of combining and optionally reacting (meth)acryloyl-functional materials, poly(meth)acrylate materials, epoxides, initiators, and any adjuvants. See, for example, U.S. Pat. No. 5,252,694 (Willett et al.), U.S. Pat. No. 5,897,727 (Staral et al.), and U.S. Pat. No. 6,180,200 (Ha et al.). Generally, any order and manner of combination can be used, provided that the composition is shielded from activating energy sources (for example, heat or light, depending upon the type of initiator that is included in the composition).

Mechanical stirring (for example, using an extruder or a Brabender mixer) can preferably be employed to ensure adequate mixing of the composition components. Solventless conditions can be utilized, if desired (for example, when using a photoinitiator and a liquid reactive diluent), but the use of one or more solvents that can substantially dissolve all composition components (for example, organic solvents such as esters or ketones) can be preferred. Early addition of higher molecular weight components can facilitate their dissolution.

The poly(meth)acrylate, epoxide, and (meth)acryloyl-functional components can be included in the curable composition in any relative amounts that, in combination with initiator and any optional components, will result in a useful balance of properties (for example, optical clarity, PSA or heat-activatable characteristics, peel strength, and/or heat and humidity stability) of the cured and/or uncured composition (preferably, producing at least an optically clear, stable, cured material). The poly(meth)acrylate can be included in an amount (for example, from about 40 to about 70 weight percent, based upon the total weight of the composition) sufficient to provide the curable composition with the functional properties of a pressure sensitive adhesive, including a useful amount of tack or tackiness, cohesiveness and handleability, and other PSA properties.

The epoxide component can be included in the composition in an amount sufficient to provide a desired structural strength (and preferred stability and clarity) for a given application. Preferably, an amount of epoxide component can be included to provide a sufficient bond strength to maintain the optical clarity of the composition over time under the expected use conditions. The required bond strength will depend on the particular materials being bonded, but preferred amounts of epoxide component can provide compositions that will not bubble or delaminate over time when used to bond an outgassing material to a low moisture vapor transmission material. Preferably, the amount of epoxide component will be sufficiently high to provide such structural bond strength, but will also be sufficiently low that the composition can maintain a sufficiently small domain size and degree of phase separation that it will not significantly scatter visible light. Greater phase separation can be acceptable, however, when the refractive indices of the respective phases are essentially the same.

Thus, the epoxide and poly(meth)acrylate components can be included in the composition in relative amounts that will provide a desired combination of pressure sensitive adhesive properties, structural bond properties, and optical clarity, with stability of these properties over time during use. In general, depending on factors such as the chemical identities and molecular weights, amount of crosslinking, and so forth, of the epoxide component and poly(meth)acrylate, among other variables, less than about 60 parts by weight epoxide component based on 100 parts by weight of the total composition can provide a cured composition that will have acceptable optical clarity. Preferred amounts can be less than about 55 or 50 parts by weight epoxide component based on one hundred parts by weight of the total composition. At the low end, an amount of epoxide component useful to provide sufficient bond strength can depend on factors such as the type of epoxide component and poly(meth)acrylate, but, in general, useful amounts can be from at least about 5 parts by weight epoxide component based on 100 parts by weight of the total composition. A preferred range can be from about 20 to about 40 parts by weight epoxide component based on one hundred parts by weight of the total composition.

The (meth)acryloyl-functional monomers and/or oligomers can be chosen and provided in amounts such that the composition can have a desirable balance of cohesive and adhesive strength (in addition to optical clarity and heat/humidity stability). The monofunctional and multifunctional components can be present in sufficient amounts relative to each other that the composition can achieve and maintain that balance. Insufficient amounts of multifunctional monomers and/or oligomers, for example, can result in a lack of cohesive strength. Excessive amounts of multifunctional component can result in a composition that is too highly crosslinked (having an average molecular weight between crosslinks, M_{c}, that is too low), which can have detrimental effects on the adhesive strength of the composition.

The composition of the invention can contain a greater amount of monofunctional monomer and/or oligomer than multifunctional. This can aid in achieving an optically clear and stable cured composition. For example, the weight ratio of the amount of monofunctional component to multifunctional component can be about 0:1 to about 30:1 (preferably, about 2:1 to about 5:1). This ratio can, of course, be adjusted according to the molecular weights (and functionalities) of the monomers and/or oligomers.

The mono- and multifunctional monomers and/or oligomers can be present in amounts relative to the amounts of poly(meth)acrylate and epoxide components (and the total weight of the composition) that provides a desired combination of pressure sensitive adhesive properties, structural bond properties, optical clarity, and stability of these properties over time. For example, the (meth)acryloyl-functional monomers and/or oligomers can constitute from about 10 to about 50 weight percent of the total composition. The multifunctional (or crosslinking) components can range in amount, for example, from about 0.1 to about 30 parts by weight (preferably, from about 0.1 to about 10 parts by weight) per one hundred parts by weight of the total composition. Amounts outside of this range can also be useful, with a particular amount for any composition depending on a variety of factors including the nature of the components and the desired properties of the cured and uncured composition.

Useful amounts of free radical initiator will be those that are sufficient to cause reaction, polymerization, and/or crosslinking of the composition. Typical amounts can be in the range from about 0.01 to about 10 parts by weight free radical initiator per one hundred parts by weight total (meth)acryloyl-functional and poly(meth)acrylate content of the composition, with a range from about 0.01 to about 5 parts by weight being preferred and from about 0.1 to about 1 part by weight being more preferred.

The composition can contain an amount of cationic initiator sufficient to cause curing of the epoxide component of the composition (in particular, an amount suitable for the selected amount and chemistry of the epoxide component(s)) to provide a useful structural adhesive bond. Typical amounts of cationic initiator can be in the range from about 0.1 to about 10 parts by weight cationic initiator per one hundred parts by weight epoxide component, with a range from about 0.1 to about 5 parts by weight being preferred and from about 0.5 to about 3 parts by weight being more preferred.

The optional components can be included in the curable composition in amounts that do not significantly interfere with the curing of the composition and with the desired properties of the cured or curable composition (including, for example, its optical, mechanical, and adhesive properties).

Application and Curing of Composition

The curable composition of the invention can be applied to a liner or a substrate by any conventional application method, including but not limited to the following: gravure coating, curtain coating, slot coating, spin coating, screen coating, transfer coating, brush or roller coating, and the like, and combinations thereof (when the composition comprises solvent), and using a Brabender mixer, a melt blender, an extruder, or a grid melter in conjunction with a drop die or a rod die, and the like, and combinations thereof (when the composition is solventless). The thickness of a coated layer, typically in the form of a liquid prior to drying, is in part dependent on the nature of the materials used and the specific properties desired, but those properties and the relationship of thickness to the properties is well understood in the art. Exemplary dried thicknesses of a curable layer can be in the range from about 0.05 to about 100 micrometers.

The dried and/or cooled (for example, to ambient temperatures) uncured composition can exhibit pressure sensitive adhesive characteristics or, alternatively, it can be a heat-activatable adhesive (which can be essentially non-tacky at ambient temperatures and become tacky at elevated temperatures). This can allow the uncured composition to be conveniently and accurately applied and positioned (for example, between a substrate and a material to be bonded to the substrate), as well as subsequently re-positioned. Subsequently, the curable composition can be cured to create a structural bond.

Radiation sources that provide light in the region from 200 to 800 nanometers (nm) can be effective for curing the composition. A preferred region is between 250 and 700 nm. Suitable sources of radiation include mercury vapor discharge lamps, carbon arcs, quartz halogen lamps, tungsten lamps, xenon lamps, fluorescent lamps, lasers, sunlight, and the like, and combinations thereof. The required amount of exposure to effect cure can depend on factors such as the identity and concentrations of particular free radically- and cationically-polymerizable components, the thickness of the exposed composition, the type of substrate, the intensity of the radiation source, and the amount of heat associated with the radiation. Useful heat sources for thermal curing include, for example, infrared lamps, ovens (including microwave ovens), hot air streams (for example, from a heat gun), heating plates and presses, induction heaters, and the like, and combinations thereof (which can optionally be part of a process such as thermoforming or injection molding).

Optionally and preferably, the poly(meth)acrylate and epoxide components, upon cure, can form an interpenetrating polymer network (IPN). Such an IPN can comprise the poly(meth)acrylate and polyepoxide components mechanically connected through the intertwining and entanglement of their polymer chains. The mechanically connected nature of the IPN adds strength and integrity to the composition and can prevent gross or large-scale phase separation and loss of clarity.

In a second form of IPN, the poly(meth)acrylate and polyepoxide components can be chemically connected through inter-reaction. That is, the polyepoxide can be directly or indirectly chemically bonded to the poly(meth)acrylate through reactive functional groups that can react directly or indirectly with each other. For example, an epoxide group can directly react with a hydroxyl or carboxylic acid group of the poly(meth)acrylate. Alternatively, the poly(meth)acrylate and polyepoxide can be chemically bonded through an intermediate chemical component such as a multifunctional monomer, polymer, macromer, or oligomer. The intermediate chemical component can chemically connect the polyepoxide to the poly(meth)acrylate, producing an inter-reacted IPN that can have even further increased integrity and optical clarity (relative to a mechanically connected IPN).

The composition of the invention is optically clear in both its uncured and cured states. Preferably, the composition can also maintain optical clarity for a useful period of time under normal use conditions and as shown by accelerated aging tests. Optical clarity can be measured in a number of different ways, as will be appreciated by the skilled artisan, including measurement according to test method ASTM-D 1003-95. When so measured, preferred uncured compositions of the invention can exhibit a luminous transmission of at least about 90 percent, and haze of less than about 2 percent. The opacity of the compositions can also be measured (for example, according to the test method set forth in the Examples section below), and preferred uncured compositions of the invention can exhibit an opacity of less than about 1 percent. Upon curing, optical clarity of preferred cured compositions, can be in the same ranges.

Preferably, the curable composition does not cause a decrease in the luminous transmission of a multi-layer article (for example, a laminate) relative to that of the corresponding article without the composition present. Thus, it can be useful to measure the luminous transmission of a laminate by using its most transmissive component as a reference. For example, for a glass/curable composition/polymer film laminate, glass can be used as the reference (that is, the transmission through the glass can be set as 100 percent transmission), and the percent transmission of the laminate can be relative to that of glass alone.

Preferred compositions can maintain their optical clarity over the useful life of the composition. Such compositions can also preferably maintain their bond strength, so as to resist or avoid delamination or bubbling and thereby maintain optical clarity in a multilayer product. Such stability and retention of optical transmissivity can be measured by accelerated aging tests, in which samples of composition optionally bonded to one or two other materials can be exposed to elevated temperature, optionally with elevated humidity conditions, for a period of time. Preferred compositions of the invention can retain their optical clarity after such accelerated aging tests as follows: after aging a cured composition at 90° C. for 500 hours in an oven for accelerated aging without humidity control, the luminous transmission of the cured and aged composition can be greater than 90 percent, its haze can be less than 2 percent, and its opacity can be less than 1 percent. In such a test, at 90° C. the uncontrolled relative humidity can typically be below 10 or 20 percent.

Alternatively, using a different accelerated aging test, after accelerated aging of a cured composition at 80° C. and 90 percent relative humidity in an oven with temperature and humidity control for 500 hours, the luminous transmission of the cured and aged composition can be greater than 90 percent, its haze can be less than 2 percent, and its opacity can be less than 1 percent.

Transfer Tapes and Optical Articles

The curable composition of the invention can be coated on at least a portion of at least one major surface of a release liner (and, optionally, a second release liner applied to the resulting exposed surface of the composition), so as to form a transfer tape comprising a film of the composition bome on at least one release liner. Exemplary release liners are well-known, commercially available, and include paper and film liners coated with release agents such as silicones, fluorocarbons, and so forth (for example, such as the T-30 liner available from CP Film, Martinsville, Va.).

The composition of the invention, being optically clear, can be useful in bonding together components of a variety of optical articles. More generally, the composition can be useful in bonding together any type of article, but the composition is particularly useful if the article requires or can benefit from an optically transmissive or clear adhesive.

Optical articles include articles that can have an optical effect or optical application (for example, screens for computers or other displays). Components of such articles include polarizing coatings or films and reflective coatings or films (including selectively reflective layers such as infrared reflective, optically clear layers).

The composition of the invention can be used to bond together one or more different optical materials or substrates (for example, layers or films that are at least partially optically transmissive, reflective, polarizing, or optically clear). Optical articles typically include a number of layers of different optical substrates, which can be any one or more of polymer, glass, metal or metallized polymer, and pressure sensitive or structural adhesive materials. Any one or more of these substrates can be used to provide a desired physical property (such as flexibility, rigidity, strength, or support), or can be one or more of reflective, partially-reflective, antireflective, polarizing, selectively transmissive or reflective with respect to different wavelengths, and is typically sufficiently optically transmissive to function within an optical article. Any one or more of the layers of the optical article can comprise an outgassing substrate or a low moisture vapor transmissive substrate.

Examples of rigid substrates that can be included to provide support for an optical article include glass and polymeric materials such as polycarbonates, poly(meth)acrylates, polyesters, and the like, and combinations thereof. Often such rigid polymeric materials, especially when relatively thick (for example, in the range of millimeters or centimeters), can exhibit a property of outgassing. This is a well-known and frustrating problem associated with optical articles. The outgassing problem can be exacerbated if an outgassing layer is bonded to a layer that does not allow the gas (for example, water vapor) to pass through, but rather acts as a barrier to the gas. This can result in the gas collecting at an adhesive interface and causing bubbling or delamination, reduced bond strength, and/or loss of clarity. The composition of the invention exhibits relatively high bond strength and stability, however, and can be used to bond an outgassing layer to a low moisture vapor transmissive layer without exhibiting significant bubbling and/or edge lifting under typical use conditions.

Outgassing substrates include polycarbonates (for example, having a thickness of at least about one to three millimeters) and poly(meth)acrylates (for example, polymethyl methacrylate having a thickness of at least about one to three millimeters). Substrates having low moisture vapor transmission rates are also known and include certain types and constructions of films, including polymeric films bearing moisture-barrier coatings.

For example, materials that have a moisture vapor transmission rate of 30 grams per meter squared per 24 hours, or less, can be considered to be low moisture vapor transmissive substrates (as measured by ASTM E96-80). Other materials that can be considered to exhibit low moisture vapor transmission rates have a transmission rate that is below about 20 grams per meter squared per 24 hours, especially a transmission rate below about 10 or even 5 grams per meter squared per 24 hours (as measured by ASTM E96-80). The threshold level of moisture vapor transmissivity that can cause delamination, bubbling, loss of bond strength, and/or loss of clarity in a specific optical article construction can depend on various factors, including the nature of its outgassing substrate(s), the amounts of gas they tend to produce, the conditions of use, and the nature and overall strength, integrity, and stability of its adhesive(s).

Thus, the invention further relates to methods of using the curable composition to form multilayer articles or laminates. For example, such methods can comprise dispensing the composition on a substrate; optionally contacting the composition with another material or substrate, such as a different layer of a multilayer article; and curing the composition. Exemplary steps can include placement of the composition on a release liner; optional drying of an optional solvent in the composition; polymerization or curing of composition components; and other steps, techniques, and methods known to be used in the preparation of multilayer articles.

The composition of the invention can be used in methods typically understood to be useful for preparing optically clear components, optical elements, and/or optical articles. Exemplary methods of preparing optical elements include, among others, those described in U.S. Pat. No. 5,897,727 (Staral et al.), U.S. Pat. No. 5,858,624 (Chou et al.), and U.S. Pat. No. 6,180,200 (Ha et al.), the descriptions of which are incorporated herein by reference. The curable composition is typically in the form of a liquid or a low viscosity material (for example, a heat-flowable composition) that can be coated or applied by methods generally useful with liquid pressure sensitive adhesives (for example, coated on a release liner). If solvent is used, solvent can later be removed from the coated composition. An example of a useful next step is to transfer the coated but uncured composition to a substrate, typically with lamination. In certain embodiments, the composition can then be cured (for example, if the composition is intended to support another material such as a fragile material). In other embodiments, the composition-bearing substrate can then be contacted with another substrate for bonding. This step can be accomplished by lamination or otherwise. After contacting with another substrate, the composition can be cured.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

All parts, percentages, ratios, and so forth in the examples and the remainder of the specification are by weight, unless noted otherwise. Solvents and other reagents were obtained from Sigma-Aldrich Chemical Company; Milwaukee, Wisconsin, unless otherwise noted.

TABLE OF ABBREVIATIONS

| Abbreviation or | |
|---|---|
| Trade | |
| Designation | Description |
| PSA-1 | A solvent-based pressure sensitive adhesive (PSA) prepared by free radical |
| | thermal polymerization of 57.5 parts isooctyl acrylate, 35 parts methyl |
| | acrylate, and 7.5 parts acrylic acid, having an inherent viscosity of 1.8 dL/g |
| | measured in ethyl acetate. |
| EtOAc | Ethyl acetate |
| Epoxy | Aromatic difunctional epoxide commercially available as “EPON 828” |
| Resin-1 | from Shell Chemicals, Houston, TX. |
| TTE | Trimethylolpropane triglycidyl ether |
| Photoinitiator-1 | Photoinitiator salt of [(1-methylethyl)phenyl(methylphenyl)iodonium |
| | tetrakis(pentafluorophenyl)borate, commercially available as |
| | “RHODORSIL PHOTOINITIATOR 2074” from Rhodia, Incorporated, of |
| | Cranbury, New Jersey. |
| Film-1 | Multilayer infrared (IR) reflecting film (50.8 micrometers thick; having a |
| | Young's modulus of 3.83 × 10¹² Pa in the machine direction and 4.44 × 10¹² Pa |
| | in the transverse direction) comprising alternating layers of |
| | polyethylene terephthalate (PET) and poly(methyl methacrylate (PMMA), |
| | commercially available as 3M ™ Solar Reflecting Film from 3M Company, |
| | St. Paul, MN. |
| Film-2 | Multilayer optical film similar to Film-1 but having a thickness of 90 |
| | micrometers and a Young's modulus of 3.19 × 10¹² Pa in the machine |
| | direction of 3.32 × 10¹² Pa in the transverse direction. |
| Film-3 | Polyvinylidene chloride-primed VIKUITI Enhanced Specular Reflector |
| | (ESR) film commercially available from 3M Company, St. Paul, MN. |
| | (thickness of 65 micrometers) |
| Film-4 | Biaxially-oriented polypropylene film, 25 micrometers thick. |
| PMMA | Unless otherwise specified, the plates used were Optix acrylic plates, 3.0 |
| Plates | millimeters thick poly(methyl methacrylate) (PMMA), commercially |
| | available from Plaskolite, Inc., Columbus, OH. Others used were CYRO- |
| | OP3 and CYRO-FF PMMA plates commercially available from CYRO |
| | Industries, Rockaway, NJ. |
| PC Plates | 4.4 millimeters thick LEXAN polycarbonate, commercially available from |
| | General Electric, Schenectady, NY. |
| ABS | Plastic sheets 508 micrometers thick made from a copolymer of |
| | acrylonitrile, butadiene, and styrene. |
| Glass Plates | 75 millimeters × 50 millimeters × 1 millimeter Corning No. 2947 |
| | MicroSlides, commercially available from Corning Glass Works, Corning, |
| | NY. |
| ACTILANE | Difunctional acrylate diluent commercially available from AKZO NOBEL, |
| 420 | Baxley, GA. |
| CN131 | Monoacrylate oligomer commercially available from Sartomer, Exton, PA. |
| Photoinitiator-2 | Photoinitiator radical salt commercially available as IRGACURE 819 from |
| | CIBA Specialty Chemicals, Tarrytown, NJ. |
| MELAK | Melamine-crosslinked polyacrylate primer. |

### Test Methods

180° Peel Adhesion

Peel adhesion was tested using a test method that was similar to the test method described in ASTM D 3330-90, except that a preformed laminate was used instead of adhering a tape to a stainless steel substrate.

Adhesive laminates (described as film/adhesive/substrate laminates) were adhered substrate side down to the platen of a IMASS SP-2000 Peel Tester (commercially available from Instrumentors Inc., Strongsville, Ohio) using double-coated adhesive tape (commercially available from 3M Company, St. Paul, Minn., under the trade designation 3M™ 410B Double-Coated Tape). The film/adhesive was then peeled from the substrate at 180° at a rate of 30 centimeters/minute (12 inches/minute) over a five-second data collection time. The peel adhesion was measured in ounces per inch and converted to Newtons per decimeter (N/dm).

Environmental Aging Tests

Several different aging protocols were used for testing the aging properties of coated and cured laminate structures under different temperature and humidity conditions. One protocol was carried out by placing the laminate in a 90° C. oven for 500 hours and was called the “90° C./500 hour test”. Another was carried out by placing the laminate in an oven with controlled humidity at 60° C., 90 percent (%) relative humidity (RH) for 500 hours and was called the “60° C./90%RH/500 hour test”. Another was carried out by placing the laminate in an oven with controlled humidity at 80° C., 90% relative humidity for 500 hours and was called the “80° C./90% RH/500 hour test”. The results of all testing protocols were assessed by visual observation to determine whether the optical properties of the laminate were maintained. The data were reported as either “Pass” (if the laminate retained its optical clarity) or “Bubble(s)” (if bubble(s) were present in the adhesive bond line after completing the aging protocol).

Luminous Transmittance and Haze

The luminous transmittance and haze of all samples were measured according to the American Society for Testing and Materials (ASTM) Test Method D 1003-95 (“Standard Test for Haze and Luminous Transmittance of Transparent Plastic”) using a TCS Plus Spectrophotometer from BYK-Gardner Inc., Silver Springs, Md.

Opacity

The opacity of the same samples used for haze and luminous transmittance measurements was measured using the TCS Plus Spectrophotometer, with its standard size reflectance port (25 mm) installed. Diffuse reflectance (specular excluded) was measured.

Reference Optical Properties

The optical properties of the substrates Film-4 and Glass Plate were tested for luminous transmittance, haze, and opacity as a reference point for the use of these substrates in laminates. The measured reference values in percent (%) are shown in Table A below. Haze and opacity values are given for both Illuminant C with CIE 2° standard observer (C2°) and Illuminant A with CIE 2° standard observer (A2°)

TABLE A

| | Luminous | | | | |
|---|---|---|---|---|---|
| | Transmittance | | | | |
| | (%) | Haze | | Opacity | |
| | Averaged | (%) | | (%) | |
| Substrate | 380-720 nm | C2° | A2° | C2° | A2° |
| Film-4 | 92.26 | 0.5 | 0.5 | 0.6 | 0.6 |
| Glass Plate | 92.42 | 0.4 | 0.4 | 0.3 | 0.3 |

### Comparative Example C1

In a brown glass reaction vessel were placed anthracene (0.100 gram), Photoinitiator-1 (0.375 gram), and EtOAc (50 grams). After essentially all of the solids were dissolved, a solution of PSA-1 (96 grams of a 26 percent (%) solids solution in EtOAc) was added to the vessel, and the resulting mixture was mixed well. To this mixture was added Epoxy Resin-1 (17.5 grams) and TTE (0.25 gram) to give a solution of 26% solids. After mixing, the resulting solution was coated on samples of Film-1, which were either corona treated or primed as shown in Table I, and dried in a 70° C. oven for 10 minutes to yield a 37.5 micrometer thick PSA tape. Samples of this PSA tape were laminated on the PMMA Plates described in Table 1. After 24 hours dwell, the resulting laminates were irradiated (through the Film-1 side) with a Fusion UV Curing System (Gaithersburg, Md.) using a Fusion “D” bulb, 300 Watts/2.54 centimeters, 15 meters/minute (50 feet/minute), 2 passes for a total UVA (320-390 nm) dose of about 1 J/cm². After irradiation, some of the laminates were post heat-treated as shown in Table 1, and all laminates were stored at ambient temperature for 24 hours before conducting the 180° peel adhesion test as described above. Peel adhesion data are shown in Table 1 below.

TABLE 1

| | | | Post | |
|---|---|---|---|---|
| | | | Irradiation | 180° Peel |
| | Film-1 Surface | PMMA Plate | Heat | Adhesion |
| Example | Treatment | Type | Treatment | (N/dm) |
| C1-A | Corona | OPTIX | None | 67.2 |
| C1-B | MELAK | CYRO-OP3 | 90° C./30 | 69.0 |
| | Primer | | minutes | |
| C1-C | MELAK | CYRO-FF | 90° C./30 | 61.0 |
| | Primer | | minutes | |

### Example 1

In a brown glass reaction vessel were placed 9-methyl anthracene (0.400 gram), Photoinitiator-1 (0.752 gram), Photoinitiator-2 (1.056 grams), and toluene (50 grams). After essentially all of the solids were dissolved, a solution of PSA-1 (96 grams of a 26% solids solution in EtOAc) was added to the vessel, and the resulting mixture was mixed well. To this mixture was added Epoxy Resin-1 (17.5 grams), CN131 (2.08 grams) and ACTILANE 420 (0.694 gram). After mixing, the resulting solution was coated on samples of Film-I, which were MELAK primed, and dried in a 70° C. oven for 10 minutes to yield a 37.5 micrometer thick PSA tape. Samples of this PSA tape were laminated on PMMA Plates (Example 1A) and PC Plates (Example 1B). Immediately following lamination, the resulting laminates were irradiated (through the Film-1 side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, all laminates were stored at ambient temperature for 24 hours before conducting the 1800 peel adhesion test described above. Peel adhesion data are shown in Table 2 below.

### Example 2

In a brown glass reaction vessel were placed 9-methyl anthracene (0.400 gram), Photoinitiator-1 (0.752 gram), Photoinitiator-2 (1.056 grams), and toluene (50 grams). After essentially all of the solids were dissolved, a solution of PSA-1 (96 grams of a 26% solids solution in EtOAc) was added to the vessel, and the resulting mixture was mixed well. To this mixture was added Epoxy Resin-1 (1 7.5 grams), CN131 (4.68 grams), and ACTILANE 420 (1.56 grams). After mixing, the resulting solution was coated on samples of Film-1, which were MELAK primed, and dried in a 70° C. oven for 10 minutes to yield a 37.5 micrometer thick PSA tape. Samples of this PSA tape were laminated on PMMA Plates (Example 2A) and PC Plates (Example 2B). Immediately following lamination, the resulting laminates were irradiated (through the Film-1 side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, all laminates were stored at ambient temperature for 24 hours before conducting the 180° peel adhesion test described above. Peel adhesion data are shown in Table 2 below.

### Example 3

In a brown glass reaction vessel were placed 9-methyl anthracene (0.400 gram), Photoinitiator-i (0.752 gram), Photoinitiator-2 (1.056 grams), and toluene (50 grams). After essentially all of the solids were dissolved, a solution of PSA-1 (96 grams of a 26% solids solution in EtOAc) was added to the vessel, and the resulting mixture was mixed well. To this mixture was added Epoxy Resin-1 (17.5 grams), CN131 (8.022 grams), and ACTILANE 420 (2.674 grams). After mixing, the resulting solution was coated on samples of Film-1, which were MELAK primed, and dried in a 70° C. oven for 10 minutes to yield a 37.5 micrometer thick PSA tape. Samples of this PSA tape were laminated on PMMA Plates (Example 3A) and PC Plates (Example 3B). Immediately following lamination, the resulting laminates were irradiated (through the Film-1 side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, all laminates were stored at ambient temperature for 24 hours before conducting the 180° peel adhesion test described above. Additional 180° peel adhesion tests were run 48 hours and 120 hours after irradiation. Peel adhesion data are shown in Table 2 below.

TABLE 2

| | | 180° Peel | 180° Peel | 180° Peel |
|---|---|---|---|---|
| | | Adhesion 24 | Adhesion 48 | Adhesion 120 |
| | | Hours After | Hours After | Hours After |
| | | Irradiation | Irradiation | Irradiation |
| Example | Substrate | (N/dm) | (N/dm) | (N/dm) |
| 1A | PMMA | 109 | 139 | 148 |
| 1B | PC | 108 | 127 | 117 |
| 2A | PMMA | 123 | 135 | 156 |
| 2B | PC | 108 | 141 | 149 |
| 3A | PMMA | 127 | 130 | 140 |
| 3B | PC | 128 | 136 | 152 |

### Example 4

In a brown glass reaction vessel were placed 9-methyl anthracene (0.100 gram), Photoinitiator-1 (0.188 gram), Photoinitiator-2 (0.264 gram), and EtOAc (12.5 grams). After essentially all of the solids were dissolved, a solution of PSA-1 (24 grams of a 26% solids solution in EtOAc) was added to the vessel, and the resulting mixture was mixed well. To this mixture was added Epoxy Resin-1 (3.125 grams), CN131 (2.01 grams), and ACTILANE 420 (0.669 gram). After mixing, the resulting solution was coated on samples of Film-1, which were MELAK primed, and dried in a 70° C. oven for 10 minutes to yield a 37.5 micrometer thick PSA tape. Samples of this PSA tape were laminated on PMMA Plates (Example 4A) and PC Plates (Example 4B). Immediately following lamination, the laminates were irradiated (through the Film-1 side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². The irradiated laminates were subjected to the environmental aging tests described above, and the data are shown in Table 3 below.

### Example 5

In a brown glass reaction vessel were placed 9-methyl anthracene (0.100 gram), Photoinitiator-1 (0.188 gram), Photoinitiator-2 (0.264 gram), and EtOAc (12.5 grams). After essentially all of the solids were dissolved, a solution of PSA-1 (24 grams of a 26% solids solution in EtOAc) was added to the vessel, and the resulting mixture was mixed well. To this mixture was added Epoxy Resin-1 (4.375 grams), CN131 (2.01 grams), and ACTILANE 420 (0.669 gram). After mixing, the resulting solution was coated on samples of Film-1, which were MELAK primed, and dried in a 70° C. oven for 10 minutes to yield a 37.5 micrometer thick PSA tape. Samples of this PSA tape were laminated on PMMA Plates (Example 5A) and PC Plates (Example 5B). Immediately following lamination, the laminates were irradiated (through the Film-1 side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². The laminates were subjected to the environmental aging tests described above, and the data are shown in Table 3 below.

TABLE 3

| | | | | 80° C./90% |
|---|---|---|---|---|
| | | 90° C./500 | 60° C./90% RH/500 | RH/500 |
| Example | Substrate | Hour Test | Hour Test | Hour Test |
| 4A | PMMA | Pass | Pass | Pass |
| 4B | PC | Pass | Pass | Pass |
| 5A | PMMA | Pass | Pass | Pass |
| 5B | PC | Pass | Pass | Pass |

### Example 6

The adhesive prepared for Example 5 was used to make laminates of Film-2/adhesive/Film-2. The adhesive was coated on a first piece of Film-2 (surface pretreated as described in Table 4 below) and dried in a 70° C. oven for 10 minutes to yield a 37.5 micrometer thick PSA tape. Samples of this PSA tape were laminated on a second piece of Film-2 (surface pretreated as described in Table 4 below). The resulting laminates were irradiated with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm² according to the UV irradiation sequence shown in Table 4. After irradiation, all laminates were stored at ambient temperature for 4 hours before conducting the 180° peel adhesion test described above. Additional peel adhesion tests were run 48 hours after irradiation. The data are shown in Table 5 below.

TABLE 4

| | Pretreatment of | Pretreatment of | |
|---|---|---|---|
| | First Piece of | Second Piece | Irradiation-Bonding |
| Example | Film-2 | of Film-2 | Sequence |
| 6A | Corona Treated | Corona Treated | Irradiated after lamination |
| 6B | No Treatment | No Treatment | Irradiated after lamination |
| 6C | No Treatment | Corona Treated | Irradiated before lamination |

TABLE 5

| | 180° Peel Adhesion | 180° Peel Adhesion |
|---|---|---|
| | 4 Hours After | 48 Hours After |
| | Irradiation | Irradiation |
| Example | (N/dm) | (N/dm) |
| 6A | 189 | Film fractured |
| 6B | 184 | Film fractured |
| 6C | 188 | 191 |

### Example 7

The adhesive solution prepared for Example 1 was used to make laminates of Film-3/adhesive/ABS. The adhesive solution was coated on samples of Film-3 and dried in a 70° C. oven for 10 minutes to yield a 37.5 micrometer thick PSA tape. Samples of this PSA tape were irradiated (on the adhesive side) with a Fusion UV Curing System using a Fusion “D” bulb, 300 Watts/2.54 centimeters, 7.5 meters/minute (25 feet/minute), 1 pass for a total WVA (320-390 nm) dose of about 1 J/cm². After irradiation, the PSA tapes were laminated on ABS. After lamination, all laminates were stored at ambient temperature for 24 hours before conducting the 180° peel adhesion test described above. Peel adhesion data are shown in Table 6 below.

### Example 8

The adhesive solution prepared for Example 2 was used to make laminates of Film-3/adhesive/ABS. The adhesive solution was coated on samples of Film-3 and dried in a 70° C. oven for 10 minutes to yield a 37.5 micrometer thick PSA tape. Samples of this PSA tape were irradiated (on the adhesive side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, the PSA tapes were laminated on ABS. After lamination, all laminates were stored at ambient temperature for 24 hours before conducting the 180° peel adhesion test described above. Peel adhesion data are shown in Table 6 below.

### Example 9

The adhesive solution prepared for Example 3 was used to make laminates of Film-3/adhesive/ABS. The adhesive solution was coated on samples of Film-3 and dried in a 70° C. oven for 10 minutes to yield a 37.5 micrometer thick PSA tape. Samples of this PSA tape were irradiated (on the adhesive side) with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, the PSA tapes were laminated on ABS. After lamination, all laminates were stored at ambient temperature for 24 hours before conducting the 180° peel adhesion test described above. Peel adhesion data are shown in Table 6 below.

TABLE 6

| | | 180° Peel |
|---|---|---|
| | | Adhesion 24 |
| | | Hours After |
| | Adhesive Solution | Irradiation |
| Example | Used | (N/dm) |
| 7 | Example 1 | 105 |
| 8 | Example 2 | 136 |
| 9 | Example 3 | 141 |

### Example 10

In a brown glass reaction vessel were placed anthracene (0.100 gram), Photoinitiator-1 (0.188 gram), Photoinitiator-2 (0.188 gram), and toluene (25 grams). After essentially all of the solids were dissolved, a solution of PSA-1 (48 grams of a 26% solids solution in EtOAc) was added to the vessel, and the resulting mixture was mixed well. To this mixture was added Epoxy Resin-1 (8.75 grams), CN131 (1.04 grams), and ACTILANE 420 (0.347 gram) to give a solution of 27.91% solids. After mixing, the resulting solution was coated on samples of Film-4 and dried in a 70° C. oven for 10 minutes to yield a 37.5 micrometer thick PSA tape. Samples of this PSA tape were laminated on Glass Plates and irradiated through the Film-4 side with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, the optical properties of the laminates were measured according to the test methods above, and the data are shown in Table 7 below.

### Example 11

In a brown glass reaction vessel were placed anthracene (0.100 gram), Photoinitiator-1 (0.188 gram), Photoinitiator-2 (0.188 gram), and toluene (25 grams). After essentially all of the solids were dissolved, a solution of PSA-1 (48 grams of a 26% solids solution in EtOAc) was added to the vessel, and the resulting mixture was mixed well. To this mixture was added Epoxy Resin-1 (8.75 grams), CN131 (2.34 grams), and ACTILANE 420 (0.78 gram) to give a solution of 29.37 % solids. After mixing, the resulting solution was coated on samples of Film4 and dried in a 70° C. oven for 10 minutes to yield a 37.5 micrometer thick PSA tape. Samples of this PSA tape were laminated on Glass Plates and irradiated through the Film-4 side with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, the optical properties of the laminates were measured according to the test methods above, and the data are shown in Table 7 below.

### Example 12

In a brown glass reaction vessel were placed anthracene (0.100 gram), Photoinitiator-1 (0.188 gram), Photoinitiator-2 (0.188 gram), and toluene (25 grams). After essentially all of the solids were dissolved, a solution of PSA-1 (48 grams of a 26% solids solution in EtOAc) was added to the vessel, and the resulting mixture was mixed well. To this mixture was added Epoxy Resin-1 (8.75 grams), CN131 (4.011 grams), and ACTILANE 420 (1.3372 grams) to give a solution of 31.16% solids. After mixing, the resulting solution was coated on samples of Film-4 and dried in a 70° C. oven for 10 minutes to yield a 37.5 micrometer thick PSA tape. Samples of this PSA tape were laminated on Glass Plates and irradiated through the Film-4 side with a Fusion UV Curing System using a Fusion “D” bulb, 300 Watts/2.54 centimeters, 7.5 meters/minute (25 feet/minute), 1 pass for a total UVA (320-390 nm) dose of about 1 J/cm². After irradiation, the optical properties of the laminates were measured according to the test methods above, and the data are shown in Table 7 below.

TABLE 7

| | | |
|---|---|---|
| Luminous | | |
| Transmittance | | |
| (%) | Haze | Opacity |
| Averaged | (%) | (%) |

| Example | 380-720 nm | C2° | A2° | C2° | A2° |
|---|---|---|---|---|---|
| 10 | 91.26 | 0.6 | 0.6 | 0.4 | 0.4 |
| 11 | 91.22 | 0.6 | 0.6 | 0.3 | 0.3 |
| 12 | 91.31 | 0.6 | 0.6 | 0.3 | 0.3 |

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only, with the scope of the invention intended to be limited only by the claims set forth herein as follows:

We claim:

1. A curable composition comprising
(a) at least one polymer comprising polymerized units derived from at least one (meth)acryloyl-functional monomer or oligomer;
(b) at least one (meth)acryloyl-multifunctional monomer or oligomer;
(c) at least one multifunctional epoxide;
(d) at least one free radical initiator; and
(e) at least one cationic initiator;
wherein said curable composition is optically clear and remains optically clear during and after curing.

2. The composition of claim 1, wherein said composition is a pressure sensitive adhesive.

3. The composition of claim 1, wherein said composition is a heat-activatable adhesive.

4. The composition of claim 1, wherein said composition further comprises at least one (meth)acryloyl-monofunctional monomer or oligomer.

5. The composition of claim 1, wherein said composition further comprises at least one monofunctional epoxide.

6. The composition of claim 1, wherein said polymer comprises polymerized units derived from at least one acryloyl-functional monomer.

7. The composition of claim 1, wherein said polymer is a pressure sensitive adhesive.

8. The composition of claim 1, wherein said polymer has a glass transition temperature that is less than or equal to 50° C.

9. The composition of Claim I, wherein said initiators are photoinitiators.

10. The composition of claim 1, wherein said composition is at least partially-cured.

11. The composition of claim 10, wherein said composition remains optically clear after being aged at 90° C. for 500 hours and/or at 80° C. and 90 percent relative humidity for 500 hours.

12. The composition of claim 10 wherein said composition exhibits at least semi-structural peel strength.

13. The composition of claim 10 wherein said composition exhibits a luminous transmission of at least 90 percent, and haze of less than 2 percent, in a measurement of optical clarity according to test method ASTM-D 1003-95.

14. A curable composition comprising
(a) at least one pressure sensitive adhesive polymer comprising polymerized units derived from at least one acryloyl-functional monomer or oligomer;
(b) at least one acryloyl-multifunctional monomer;
(c) at least one difunctional epoxide;
(d) at least one free radical photoinitiator;
(e) at least one cationic photoinitiator; and
(f) at least one acryloyl-monofunctional monomer;
wherein said curable composition is optically clear and remains optically clear during and after curing.

15. A transfer tape comprising a film of the composition of claim 1 borne on at least one release liner.

16. An optical article comprising the composition of claim 1 and at least one optical substrate.

17. An optical article comprising the composition of claim 10 and at least one optical substrate.

18. The article of claim 17, wherein said article is a coated optical sheet.

19. The article of claim 17, wherein said article is an optical laminate.

20. The article of claim 19, wherein said optical laminate comprises at least one said optical substrate that is an infrared reflective film and at least one said optical substrate that is an outgassing substrate.

21. A process for producing an optical article comprising
(a) applying the composition of claim 1 to at least a portion of at least one surface of a first optical substrate;
(b) exposing at least said composition to actinic radiation or heat; and
(c) optionally, bonding a second optical substrate to said composition either before or after said exposing.
